(19) United States
(12) Patent Application Publication
(10) Pub. No.: US 2013/0041810 A1
(43) Pub. Date: Feb. 14, 2013

(54) PAYROLL SYSTEM TO FACILITATE EMPLOYEE BUDGET CONTROL AND METHODS THEREOF

(71) Applicants: EMANUEL B. MURRELL, Toms River, NJ (US); Ghanshyam Ratanpara, East Windsor, NJ (US)

(72) Inventors: EMANUEL B. MURRELL, Toms River, NJ (US); Ghanshyam Ratanpara, East Windsor, NJ (US)

(21) Appl. No.: 13/569,992

(22) Filed: Aug. 8, 2012

Related U.S. Application Data
(60) Provisional application No. 61/521,348, filed on Aug. 8, 2011.

(51) Int. Cl. G06Q 40/00

(52) U.S. Cl. 705/39

(57) ABSTRACT

Embodiments of the present invention generally relate to a system for administering and managing an employee's compensation by virtue of enabling the employee to implement measures to create a budget and implement such budget through controlled distribution of the employee's compensation. In one embodiment, the method comprises: receiving employee data regarding the employee's compensation from an employer, the employee data comprising an employer pay schedule and an ordinary pay amount each pay period of the pay schedule; enabling the employee to create a customized periodic payment plan; and managing implementation of the customized periodic payment plan, whereby the employee is compensated based on the customized pay schedule at a modified pay amount for each pay period of the customized pay schedule.

### CROSS-REFERENCE TO RELATED APPLICATIONS

This Application claims priority to U.S. Provisional Patent Application Ser. No. 61/521,348, filed Aug. 8, 2011, entitled “Employee Payroll System and Methods Thereof,” the disclosure of which is incorporated herein by reference in its entirety.

### BACKGROUND

1. Field of the Invention

Embodiments of the present invention generally relate to a payroll system to facilitate employee budget control and methods thereof. More specifically, embodiments of the present invention relate to a system for administering and managing an employee's compensation by virtue of enabling the employee to implement measures to create a budget and implement such budget through controlled distribution of the employee's compensation.

2. Description of Related Art

Successful businesses around the world have one thing in common: they budget their money. Although making money and making a budget appear to go hand-in-hand, a report on personal income and outlays by the U.S. Department of Commerce found that for 2006, American households had a negative savings rate of around −1.0%, indicating a spending of one percent over earnings. The study found that the overwhelming majority of Americans do not have or correctly use a personal budget to permit them to dedicate so much of their earnings towards specific goods or services, and still have money left over for savings or personal “extras.”

Budgets are often viewed as restrictive reminders of things people cannot have. However, a budget should properly be viewed as a tool, which when used properly, leads to a desired outcome—i.e., to have a fiscally responsible lifestyle. As a budget is nothing more than a plan for how people will spend their money, it should be treated as a roadmap for every paycheck received.

Even for people who understand budgets and try to live by one, it can often be difficult to have the self-restraint to follow the budget once the paycheck is cashed and the money is in the bank. Knowing the next paycheck will not come for another week, two weeks, or even a month, can be frustrating and can lead people to want to delay paying their bills right away, to ensure they have as much money as possible to get through the next pay period. However, in the event they end up spending money in the bank that was budgeted for some other purpose, they end up falling behind on their bills, using their credit cards, or some other action that negatively affects their efforts to budget and save money.

As most are aware, the path of using credit cards, borrowing from savings, etc., can be a slippery slope. Not only does is act negatively against one's savings rate, which should always be positive to be considered fiscally responsible, but it creates a new liability (e.g., a monthly bill), which now must be budgeted for to get back to a proper course of savings.

Currently, there are few tools in the marketplace that assist an individual to save money and budget properly. Most tools are in the form of worksheets, spreadsheets, or similar computer programs (e.g., QuickBooks, Quicken, Microsoft Money, etc.) that provide reminders for when bills are coming due, allow people to dedicate (on paper) money to certain liabilities, and show long term predictions for when savings goals will be hit. However, none of such tools actually integrate within the individual's bank accounts to facilitate implementation and execution of a budget.

As such, there is a need for a payroll system to facilitate employee budget control and methods thereof.

### SUMMARY

Embodiments of the present invention generally relate to a payroll system to facilitate employee budget control and methods thereof. More specifically, embodiments of the present invention relate to a system for administering and managing an employee's compensation by virtue of enabling the employee to implement measures to create a budget and implement such budget through controlled distribution of the employee's compensation.

In one embodiment of the present invention, a method of facilitating employee budget control utilizing a computer system having a processor, wherein the processor executes steps of the method, comprises: receiving employee data regarding the employee's compensation from an employer, the employee data comprising an employer pay schedule and an ordinary pay amount each pay period of the pay schedule; enabling the employee to create a customized periodic payment plan, such customized periodic payment plan having a customized pay schedule different than the employer pay schedule; and managing implementation of the customized periodic payment plan, whereby the employee is compensated based on the customized pay schedule at a modified pay amount for each pay period of the customized pay schedule; wherein the customized pay schedule and modified pay amount provide a total employee compensation no greater than the employee compensation under the employer pay schedule and the ordinary pay amount, over any given period of time.

In another embodiment of the present invention, a method of facilitating employee budget control utilizing a computer system having a processor, wherein the processor executes steps of the method, comprises: receiving employee data regarding the employee's compensation from an employer, the employee data comprising an employer pay schedule, an ordinary pay amount each pay period of the pay schedule, and employee spending habits; electronically verifying at least a portion of the employee data with the employer; enabling the employee to create a customized periodic payment plan, such customized periodic payment plan having a customized pay schedule different than the employer pay schedule; and facilitating the processing of a receipt of the ordinary pay amount from the employer according to the employer pay schedule, and payment to the employee of the modified pay amount according to the customized pay schedule; wherein the customized pay schedule and modified pay amount provide a total employee compensation no greater than the employee compensation under the employer pay schedule and the ordinary pay amount, over any given period of time.

In yet another embodiment of the present invention, a method of facilitating employee budget control utilizing a computer system having a processor, wherein the processor executes steps of the method, comprises: receiving employee data regarding the employee's compensation from an employer, the employee data comprising an employer pay schedule, and an ordinary pay amount each pay period of the pay schedule; determining a periodic pay rate of the employee based upon the employer pay schedule and ordinary pay amount for each pay period of the pay schedule, such periodic pay rate indicative of when an employee earns compensation that is to be received during a subsequent pay period of the pay schedule; issuing credits to an employee account stored in a database within the computer system in accordance with the periodic pay rate, the credits being issued being provided in an amount no greater than the value amount of the periodic pay rate; enabling the employee to redeem the issued credits at third party merchants; and facilitating the deduction of the amount of redeemed issued credits from the ordinary pay amount in a subsequent pay period of the pay schedule.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts a block diagram of an exemplary system in accordance with one embodiment of the present invention;

FIG. 2 depicts a block diagram of a general purpose computer system in accordance with one embodiment of the present invention;

FIG. 3 depicts a general flow chart of a method of administering an employee payroll system in accordance with one exemplary embodiment of the present invention; and

FIG. 4 depicts a general flow chart of a method of administering an employee payroll system in accordance with another exemplary embodiment of the present invention.

The headings used herein are for organizational purposes only and are not meant to be used to limit the scope of the description or the claims. As used throughout this application, the word ^{may} is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

In the following detailed description, numerous specific details are set forth in order to provide a thorough understanding of exemplary embodiments or other examples described herein. However, it will be understood that these examples may be practiced without the specific details. In other instances, well-known methods, procedures, and components have not been described in detail, so as to not obscure the following description. Furthermore, the examples disclosed herein are for exemplary purposes only and other examples may be employed in lieu of, or in combination with, the examples disclosed.

Embodiments of the present invention generally relate to a payroll system to facilitate employee budget control and methods thereof. More specifically, embodiments of the present invention relate to a system for administering and managing an employee's compensation by virtue of enabling the employee to implement measures to create a budget and implement such budget through controlled distribution of the employee's compensation.

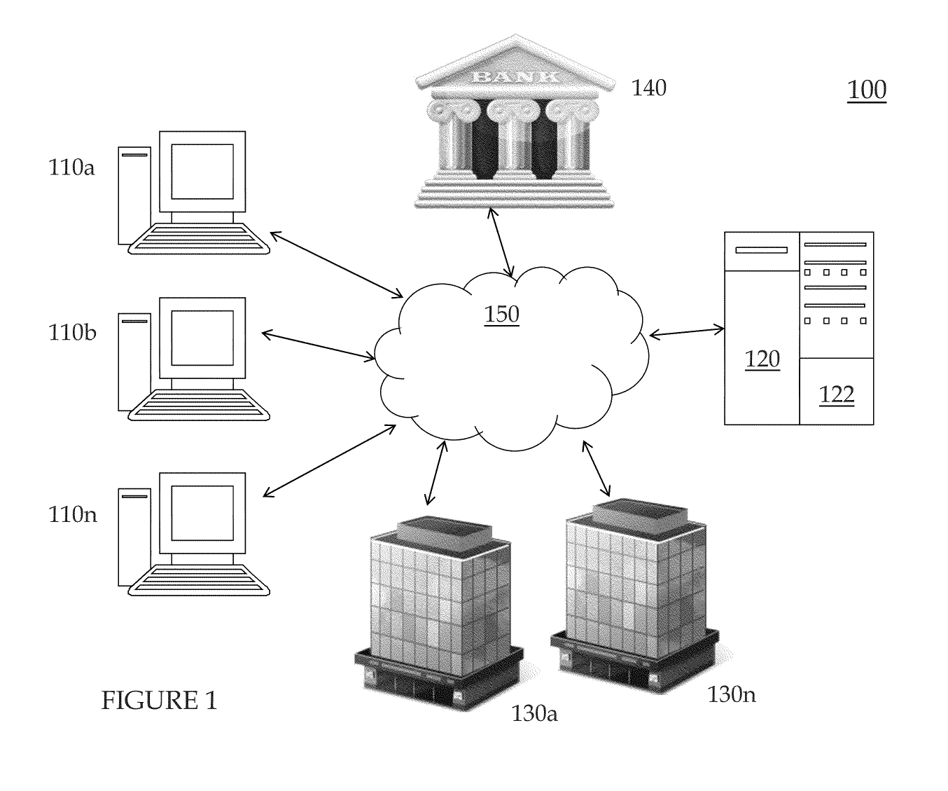

FIG. 1 depicts a block diagram of an exemplary system in accordance with one embodiment of the present invention. The system 100 generally includes at least a first user 110a, also referred to herein as an employee, a first employer 130a, an administrator 120, and optionally a financial institution 140, all in communication via a network 150. The system 100 may additionally include at least a second user 110b, and additional users, up to user 110n, where n represents any number of users practical for operation of embodiments of the present invention.

The network 150 may comprise any network suitable for embodiments of the present invention. For example, the network 150 may be a partial or full deployment of most any communication/computer network or link, including any of, any multiple of, any combination of or any combination of multiples of a public or private, terrestrial wireless or satellite, and wireline networks or links. The network 150 may include, for example, network elements from a Public Switch Telephone Network (PSTN), the Internet, core and proprietary public networks, wireless voice and packet-data networks, such as 1G, 2G, 2.5G, 3G and 4G telecommunication networks, wireless office telephone systems (WOTS) and/or wireless local area networks (WLANs), including, Bluetooth and/or IEEE 802.11 WLANs, wireless personal area networks (WPANs), wireless metropolitan area networks (WMANs) and the like; and/or communication links, such as Universal Serial Bus (USB) links; parallel port links, Firewire links, RS-232 links, RS-485 links, Controller-Area Network (CAN) links, and the like.

The administrator or host 120 may comprise an organization, company or individual who controls, designs and is generally responsible for implementing and/or facilitating each of the methods disclosed herein. In one embodiment, the administrator 120 is an entity hosting an accessible server and a database 122. The server may comprise any type of computing device suitable for embodiments of the present invention. The server may be located at the administrator 120 physical site or at a remote location accessible via the network 160.

The database 122 may include a number of records in accordance with embodiments of the present invention, including data and/or other information, which may be parsed and stored. The database 122 may further comprise software, which may include and/or employ one or more database management systems (“DBMS”), such as any one of an Oracle, DB2, Microsoft Access, Microsoft SQL Server, Postgres, MySQL, 4th Dimension, FileMaker and Alpha Five DBMS, and the like. The DBMS may be operable to query the database 122, parse the information into the records, execute rules for sorting the information parsed into the records, execute rules for performing operations (e.g., mathematical, statistical, logical, etc., operations) on the information parsed into the records, and the like.

In many embodiments, the database software may be operable to apply the data from records into one or more models to form one or more output records. These output records include information that may be used to facilitate the methods disclosed herein. In addition, the database software may be operable to interface with web-server software, to allow manipulation of the database 122 via one or more web pages available to the administrator 120 and/or users 110 via the network 150.

Optionally, the system 100 may also comprise a third party financial institution 140. The financial institution 140 may comprise a bank, a credit-based company, or the like, suitable for facilitating the financial transactions within the system. In many embodiments, the financial institution 140 comprises a system for accepting, storing, tracking and processing payments made within the system 100.

The system 100 comprises a first employer 130a, also referred to herein as an organization. The system 100 may additionally include at least a second organization, and additional organizations, up to organization 130n, where n represents any number of organizations practical for operation of embodiments of the present invention. In many embodiments, the employer 130 employs at least one employee 110. The nature of the employment may constitute any type of legal employment suitable for embodiments of the present invention, including full or part-time work, whereby the employee 110 receives compensation from the employer 130 for the employment. In certain other embodiments, the employer/employee relationship may be in the form of a government entity and an entitlement payment (e.g., social security, welfare, etc.)

In accordance with many embodiments of the present invention, each of the parties associated with the system 100 comprise the necessary electronic devices, having platforms and databases where applicable, to execute the methods as set forth by embodiments of the present invention. Alternative system architectures are contemplated by embodiments of the present invention, provided such alternative architectures are capable of executing the various methods disclosed herein.

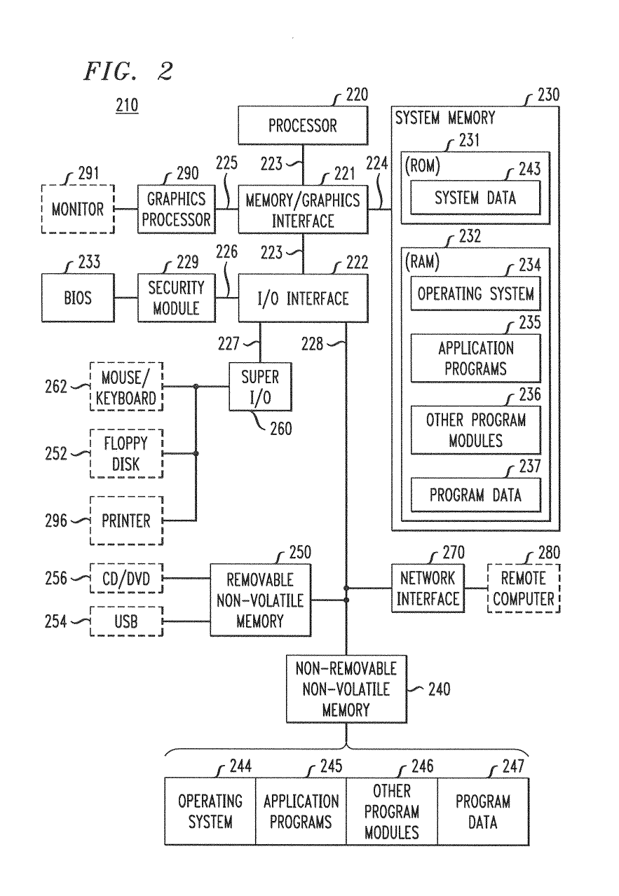

In several embodiments, the electronic device associated with each of the parties within the system comprises a general purpose computer system, for example, the general purpose computer system of FIG. 2. It should be appreciated, however, the general purpose computing system of FIG. 2 is merely an exemplary embodiment of an electronic device, and actual electronic devices may comprise any one or more components shown in FIG. 2, suitable for embodiments of the present invention.

With reference to FIG. 2, a general purpose computer system in the form of a computer 210 is shown. As understood by embodiments of the present invention, components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and can accessed by the computer 210.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other buses 226, 227 and 228 that couple a variety of internal and external devices to the computer 210. A serial peripheral interface (SPI) bus 226 may connect to a BIOS memory 233 containing the basic routines that help to transfer information between elements within computer 210, such as during start-up.

In some embodiments, a security module 229 may be incorporated to manage metering, billing, and enforcement of policies.

A super input/output chip 260 may be used to connect to a number of ‘legacy’ peripherals, such as floppy disk 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 252 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media, discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different elements within the computer 210. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), an Ethernet-based network, a wide area network (WAN), or both, but may also include other networks. Such networking environments are commonplace in offices, enterprise-wide computer networks, intranets, and the Internet.

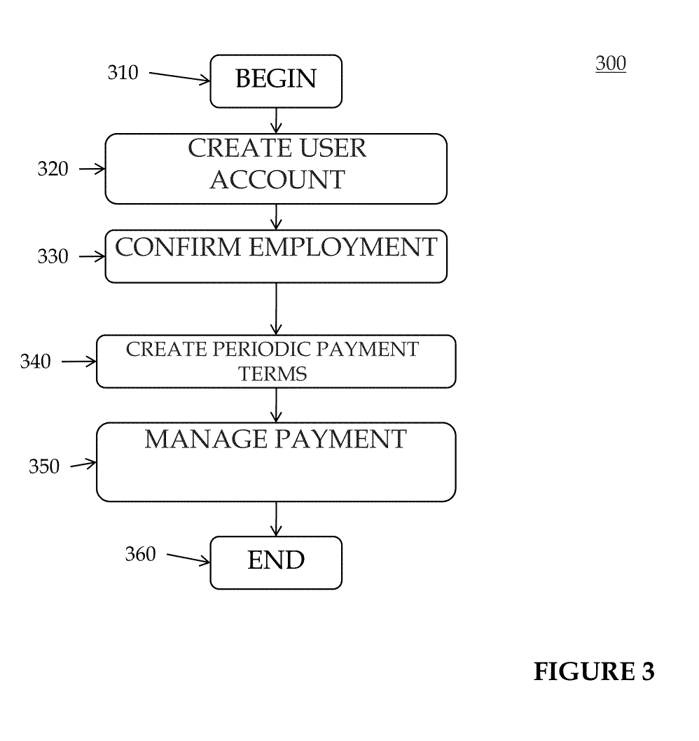

FIG. 3 depicts a general flow chart of a method of administering an employee payroll system in accordance with one exemplary embodiment of the present invention. The method 300 begins at step 310 where a system, such as the system 100 of FIG. 1, is provided. At step 320, an administrator creates a user account. In one embodiment, the creation of the user account comprises the establishment of an account within the database 122, and creating access for the user 110 to access its account. In many embodiments, such access comprises the use of a web portal, software application, or the like.

Generally, where an account is created on the database 122 for a user 110, information is gathered from the user during a “registration” page, accessible via the global computer network. For example, in one embodiment, a user 110 may provide certain information relating to unique characteristics of the user 110, e.g., current employment information, financial information, demographic information, personal information, geographical information, and/or the like. In certain embodiments, when creating the user account, the administrator 120 may classify and/or categorize the user into one or more of several plausible groups. Such types of groups may be based on occupations, employers, divisions within a company, interests, or the like, as provided by the user 110.

In certain embodiments, the administrator may also collect information regarding the employee's spending habits, spending requirements, personal financial situations, and the like. In such embodiments, such information may be detailed (e.g., providing down-to-the-penny accounting of monthly expenses), generic (e.g., providing numbers rounded to the nearest hundred dollars), or combinations thereof (e.g., providing specific numbers with regard to installment payments, and broad ranges for other numbers). Such collected information may be utilized to assist in later steps within the method 300.

At step 330, the administrator may confirm employment of the user. For example, in one embodiment, if the user indicated she was an employee of a particular company, the administrator may request employment identification (e.g., employer information, an employee ID number, an account number, etc.). In another embodiment, the administrator may request specific information regarding the compensation of the employment, for example, the amount of total compensation, frequency of payment (i.e., every other week, once a month, weekly, etc.), a bonus/commission structure, etc. In certain embodiments, the administrator may already be in possession of the nature of information used by a particular employer (i.e., the administrator may be in communication with the employer, and may already have access to all personnel and employment files). In such embodiments, the administrator may only need basic information from the user to subsequently verify the user's employment with the employer.

Also at step 330, the administrator may verify the information provided by the employee with employer. In one embodiment, the administrator 120 may communicate directly with an employer 130 through the network 150. In such an embodiment, by utilizing the identifying information provided by the employee 110, the employee's employment and related information may be automatically confirmed by a database at the employer. In another embodiment, alternative forms of communication, for example, telephone, facsimile, or the like, may be utilized to obtain some type of confirmation of the employee's employment with the employer.

At step 340, the administrator 120 may assemble the data compiled from the employer and employee and create a customized periodic payment plan with the employee. In one embodiment, the administrator compiles financial data from the employee. In many embodiments, such financial data includes at least the employee's compensation over a periodic time (e.g., week, month, year, etc.). In other embodiments, the financial data being compiled may also include the employee's spending parameters.

Once the data is compiled, the administrator may ask the employee to set a desired periodic payment plan. For example, if the employee is making $1000 every two weeks, the employee may desire to be paid out $500 every week, or $2000 every four weeks. In another embodiment, for an employee who has a lot of bills circulating near the first of the month, the employee may want to make 80% of her monthly salary on the last Friday of the month and the remainder of the salary split over every other Friday within the month. In yet another embodiment, an employee may be paid twice a month (e.g., the 1st and 15th of the month), and may want to be paid a large portion of her monthly income on the 1st of the month, and the remainder of her monthly income spread out in small increments over every Monday, Wednesday and Friday of the month.

In certain embodiments, where the administrator is aware of the employee's spending habits, the administrator may recommend a particular payment plan for the employee's approval. For example, the administrator may determine that the employee spends a substantial amount of money during a particular time of the month, and the administrator may suggest the employee receive a greater percentage of her compensation during that period of the month. Similarly, if the administrator learns that the employee runs out of spending cash after every weekend, the administrator may suggest the employee receive an even payment every Monday.

In further embodiment, the administrator may act in the role of a financial advisor and suggest financial strategy in addition to just a payment plan. For example, the administrator may learn that the employee is paying high interest rates on credit cards and only making minimal payments. As such, the administrator may recommend a financial strategy to pay down such credit card balances, which may include a percentage of the employee's monthly compensation going to the credit card, and the employee could receive such percentage of compensation on or near the date on which the credit card is due. Similarly, in another embodiment, the administrator may determine long term goals of the employee, such as retirement goals. As such, the administrator may suggest certain payment plan options that could include ways to save money towards retirement.

In yet further embodiments, the administrator may take on an additional role of third party payment processor. For example, in certain embodiment, the employee may identify certain installment payments that need to be paid every month. The administrator may automatically deduct such amount from the employee's payment plan and pay the third party (e.g., mortgage company, car finance company, credit card company, etc.) directly. In such embodiments, the employee may receive only the compensation remaining after all her requisite monthly bills are paid.

At step 350, once the administrator has acquired all information, verified the information with the employer, and set out a payment plan with the employee, the administrator manages the employee's compensation or payment plan. In many embodiments the management of an employee's payment plan comprises accepting payments from the employer as if the employer were paying directly to the employee, and remitting payments to the employee in accordance with the terms of the payment plan.

In some embodiments, the administrator may generally work closely with a financial institution, such as a bank, payroll company, credit company, or the like, to facilitate in the processing of such payments. In some embodiment, the financial institution may receive payments from the employer on an ordinary payroll schedule for the employer, and hold such funds in an escrow or trust account for the employee. Such receipt of payment may occur via direct deposit, mailing/delivering a check, electronic funds transfer, wire transfer, or the like.

Once the administrator (or financial institution) obtains the funds from the employer, it may distribute the funds according to the payment plan. Such distribution may occur via direct deposit, mailing/delivering a check, electronic funds transfer, wire transfer, or the like. In certain embodiments, where payment to third parties may be made under the payment plan, the administrator may process payment to such third parties via any means suitable for embodiments of the present invention. In many of such embodiments, the payment may be made via any type of bill payment structure offered by many financial institutions.

The method 300 ends at step 360. It should be appreciated however, that as long as the employee remains employed, the steps 330-350 may continue perpetually until the user no longer is employed with an employer, or elects not to utilize the systems and methods described herein.

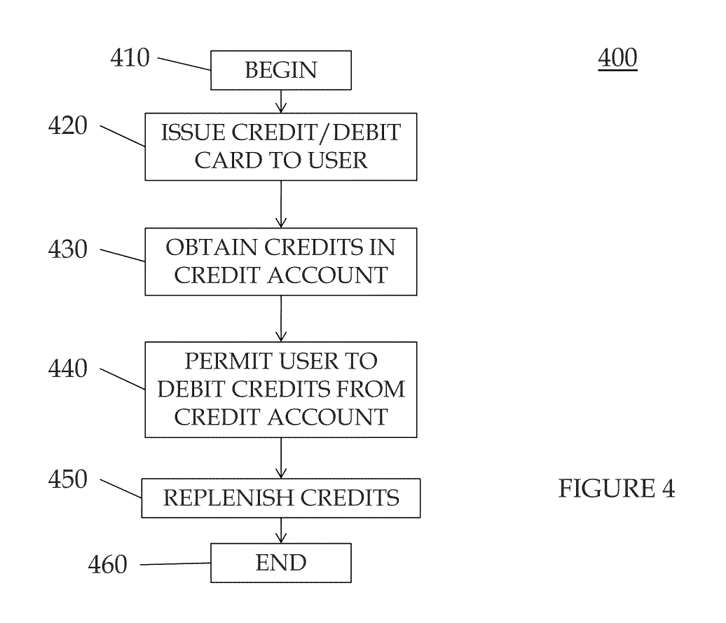

FIG. 4 depicts a general flow chart of a method of administering an employee payroll system in accordance with another exemplary embodiment of the present invention. The method 400 begins at step 410 where a system, such as the system 100 of FIG. 1, is provided. At this beginning step 410, a user account may be established, employment may be confirmed and/or validated, as done in method 300.

At step 420, the user may be issued a tangible card having encoded information thereon relating to the user account. While a traditional credit or debit card, as known in the industry, may be utilized, embodiments of the present invention may utilize any type of tangible card or article capable of storing information thereon. In many embodiments, the tangible card comprises a magnetic strip on one side thereof, for storing information thereon. In other embodiments of the present invention, the tangible card may comprise an RFID chip, a barcode, a QR code, a computer chip, or the like, for storing information relating to the user account.

At step 430, the user may start accumulating credits within a credit account associated with the user account. In many embodiments, in order to accumulate credits, the administrator may determine a periodic pay rate of the user based upon the employer's pay schedule and ordinary pay amount for each pay period of the pay schedule. For example, if the employer pays the employee $1,000 per every two 5-day work weeks (i.e., bi-weekly), the periodic pay rate of that user may be either $500/week or $100 per day. Using the daily rate, for purposes of example, it can be determined that for every day the user works, the user will be paid $100, even if it will not be received or collected for a couple weeks later.

Once the periodic pay rate of the user is determined, the credit account for the user may start accumulating credits. In the exemplary embodiment above, where the user has a periodic pay rate of $100/day, if the user works all day on a Monday, by the time the user goes home for the day, the employer owes the user $100 in compensation. Accordingly, in accordance with one embodiment of the present invention, at the end of that day, the user's credit account may receive a set number of credits having a value amount no greater than the $100 periodic pay rate. That is, if 1 credit equals the value amount of $1, the user's credit account may receive up to 100 credits at the end of each work day.

While embodiments of the present invention may permit more credits to be accumulated than the value of the periodic pay rate, it may likely increase the financial risk to the administrator, employer and/or financial institution in the event the user quits or is terminated before all accumulated credits are earned. Accordingly, in most embodiments, the rate at which the credits are accumulated is no greater than the periodic pay rate.

In certain embodiments, the user may be able to select the amount of credits accumulated into the credit account. In the example above, the user may elect to only receive credits at half of the periodic pay rate, and as such, the user may only accumulate credits at a rate of 50 credits per day worked. In many embodiments, the user may have freedom to select the amount of credits accumulated at any time throughout the use of the systems herein.

At step 440, the user is permitted to redeem the accumulated credits as soon as they are accumulated within the user's credit account. Generally, the user may redeem the accumulated credits using the tangible card at any third party merchant, similar to using a traditional credit card or debit card. A third party merchant may comprise any of a retail store (e.g., a grocery store, an electronics store, etc.), a service provider (e.g., a gas station, a plumber, an electrician, etc.), a financial institution (e.g., a bank, a credit card company, an automated teller machine (ATM), etc.), a utility provider (e.g., the gas company, the phone company, etc.), or the like. In certain embodiments, to expeditiously process data, the administrator may partner with one or more credit card companies (e.g., Visa, MasterCard, American Express, etc.), such that the credit card companies have established infrastructure for processing ordinary merchant transactions.

When processing a transaction hereunder, similar to a debit card transaction, the credit card processing company at the merchant may electronically check the value of accumulated credits within the user's credit account to ensure the transaction will clear (i.e., there are sufficient credits within the user's credit account to pay for the transaction.) If there are sufficient credits, the credits will be debited from the user's credit account and the transaction will go through successfully. If there are not sufficient credits, the transaction will be declined.

At step 450, upon completion of the next periodic pay rate interval, the credits in the user's credit account may be replenished. In certain embodiments, the entire amount of credits, as described above, may be issued to the credit account. In other embodiments, however, the credits may only be replenished up to a certain value. For example, if the credit account has a value of 100 credits, the user accumulates 100 credits at the end of day 1 and spends 25 credits on the morning of day 2, the credit account may only be credited 25 credits at the end of day 2 to bring the value of the credit account back to 100.

In accordance with certain embodiments of the present invention, the user is responsible to pay for value of any credits debited from the credit account. Accordingly, during a subsequent pay period, the user's pay may be deducted by an amount equal to the value of credits used. In some embodiments, the user's pay stub may comprise an itemized list of credit charges used before the subsequent pay period.

The method 400 ends at step 460.

As appreciated by various alternative embodiments of the present invention, the administrator 120 may provide a plethora of additional services within the system 100 to facilitate the methods disclosed herein. In particular, the administrator 120 may implement substantial tiers of security and validation beyond those described above, as necessary for embodiments of the present invention. Examples of such type of security may include: user-rating systems to unlock or remove certain levels of access within the system, financial confirmation/validation from a user's financial institution, exchange and/or validation of employer information, proof of employment with certain types of employers, or the like.

Beyond the specific methods and architectures disclosed herein, it should be appreciated that embodiments of the present invention may further comprise additional components, methods, or entities, provided such unique business processes as disclosed herein, are maintained. For example, the system 100 of embodiments of the present invention may comprise a plethora of additional features, for example, social networking features. As such, it should be appreciated that embodiments of the present invention may include: user-personalized webpages, chat/email functions, the ability to import and/or obtain information from an existing list (e.g., Microsoft Money, Quickbooks, etc.) or an existing social networking group (e.g., connections on LinkedIn.com, FaceBook friends, etc.), extending access to mobile and other devices, or the like.

While the foregoing is directed to embodiments of the present invention, other and further embodiments of the invention may be devised without departing from the basic scope thereof. Specifically, embodiments of the present invention are further scalable to allow for additional clients and servers, as particular applications may require.

What is claimed is:

1. A method of facilitating employee budget control utilizing a computer system having a processor, wherein the processor executes steps of the method, the method comprising:
receiving employee data regarding the employee's compensation from an employer, the employee data comprising an employer pay schedule and an ordinary pay amount each pay period of the pay schedule;
enabling the employee to create a customized periodic payment plan, such customized periodic payment plan having a customized pay schedule different than the employer pay schedule; and
managing implementation of the customized periodic payment plan, whereby the employee is compensated based on the customized pay schedule at a modified pay amount for each pay period of the customized pay schedule;
wherein the customized pay schedule and modified pay amount provide a total employee compensation no greater than the employee compensation under the employer pay schedule and the ordinary pay amount, over any given period of time.

2. The method of claim 1, further comprising electronically verifying the employee data with the employer.

3. The method of claim 1, wherein the customized period payment plan comprises data regarding employee spending habits.

4. The method of claim 3, wherein the customized period payment plan comprises a periodic deadline and an amount for an employee's periodic installment payments.

5. The method of claim 4, wherein managing implementation of the customized periodic payment plan deducts the amount for the employee's periodic installment payments from the modified pay amount, and sends the amount to a third party responsible for the employee's period installment payment.

6. The method of claim 1, wherein managing implementation of the customized periodic payment plan comprises facilitating the processing of a receipt of the ordinary pay amount from the employer according to the employer pay schedule, and payment to the employee of the modified pay amount according to the customized pay schedule.

7. The method of claim 6, wherein managing implementation of the customized periodic payment plan comprises instructing a financial institution to receive the ordinary pay amount from the employer according to the employer pay schedule, and pay the employee the modified pay amount according to the customized pay schedule.

8. The method of claim 7, wherein the financial institution is a payroll company.

9. The method of claim 7, wherein the receipt of the ordinary pay and the payment of the modified pay occur via electronic funds transfer (EFT).

10. The method of claim 1, wherein the customized pay schedule and modified pay amount provide a total employee compensation less than the employee compensation under the employer pay schedule and the ordinary pay amount, over any given period of time.

11. The method of claim 1, wherein the employee provides the employee data via a web portal accessible through a website via a global computer network.

12. The method of claim 11, wherein the web portal is accessible on a mobile device via the global computer network.

13. The method of claim 1, wherein the employee provides the employee data via upload of information from a third party financial management software platform.

14. A method of facilitating employee budget control utilizing a computer system having a processor, wherein the processor executes steps of the method, the method comprising:
receiving employee data regarding the employee's compensation from an employer, the employee data comprising an employer pay schedule, an ordinary pay amount each pay period of the pay schedule, and employee spending habits;
electronically verifying at least a portion of the employee data with the employer;
enabling the employee to create a customized periodic payment plan, such customized periodic payment plan having a customized pay schedule different than the employer pay schedule; and
facilitating the processing of a receipt of the ordinary pay amount from the employer according to the employer pay schedule, and payment to the employee of the modified pay amount according to the customized pay schedule;
wherein the customized pay schedule and modified pay amount provide a total employee compensation no greater than the employee compensation under the employer pay schedule and the ordinary pay amount, over any given period of time.

15. The method of claim 14, wherein the customized period payment plan comprises a periodic deadline and an amount for an employee's periodic installment payments.

16. The method of claim 15, wherein managing implementation of the customized periodic payment plan deducts the amount for the employee's periodic installment payments from the modified pay amount, and sends the amount to a third party responsible for the employee's period installment payment.

17. The method of claim 16, wherein managing implementation of the customized periodic payment plan comprises instructing a payroll company to receive the ordinary pay amount from the employer according to the employer pay schedule, and pay the employee the modified pay amount according to the customized pay schedule.

18. A method of facilitating employee budget control utilizing a computer system having a processor, wherein the processor executes steps of the method, the method comprising:
receiving employee data regarding the employee's compensation from an employer, the employee data comprising an employer pay schedule, and an ordinary pay amount each pay period of the pay schedule;
determining a periodic pay rate of the employee based upon the employer pay schedule and ordinary pay amount for each pay period of the pay schedule, such periodic pay rate indicative of when an employee earns compensation that is to be received during a subsequent pay period of the pay schedule;
issuing credits to an employee account stored in a database within the computer system in accordance with the periodic pay rate, the credits being issued being provided in an amount no greater than the value amount of the periodic pay rate;
enabling the employee to redeem the issued credits at third party merchants; and
facilitating the deduction of the amount of redeemed issued credits from the ordinary pay amount in a subsequent pay period of the pay schedule.

19. The method of claim 18, wherein the employee redeems the issued credits via a tangible card having encoded data regarding the employee account thereon.

20. The method of claim 19, wherein the third party merchants comprise any one of a retail store, a service provider, a financial institution, or a utility provider.
